(19) United States
(12) Patent Application Publication
(10) Pub. No.: US 2016/0184908 A1
(43) Pub. Date: Jun. 30, 2016

(54) WIRE SAWING MACHINE

(71) Applicant: Nantong Henglong Machinery Manufacturing Co., Ltd., Nantong City (CN)

(72) Inventor: Hanbo ZHU, Nantong City (CN)

(73) Assignee: NANTONG HENGLONG MACHINERY MANUFACTURING CO., LTD.

(21) Appl. No.: 14/933,040

(22) Filed: Nov. 5, 2015

(30) Foreign Application Priority Data
Dec. 30, 2014 (CN) 201410844232.5

(51) Int. Cl. B23D 59/00; B23D 57/00; B26D 7/08; B26D 1/48

(52) U.S. Cl. CPC B23D 59/001; B26D 1/48; B23D 57/003; B23D 57/0053; B26D 7/088

(57) ABSTRACT

Disclosed is a wire sawing machine which comprises a wire storage system, a working table, a cutting fluid lubrication system and a control system. The working table comprises a machine base, a linear moving table in sliding connection with the machine base for linear movement along X-axis and Y-axis directions, and a rotary table disposed above the linear moving table. The wire storage system comprises an upper wire rack and a lower wire rack, a guide wheels group for wire storage, and a cutting wire which is connected end to end passing through the upper wire rack and the lower wire rack and wound around the outside of the guide wheels group for wire storage. Thus, a closed loop cutting wire is formed to realize one-way movement of the cutting wire and reducing the stop of the wire.

### FIELD OF THE INVENTION

The present invention relates to machinery manufacturing equipment, and more particularly to a wire sawing machine which may be digitally controlled.

### BACKGROUND OF THE INVENTION

Conventional wire sawing machines on the market are all a roller on which a cutting wire is wrapped around. The cutting wire moves from one end to the other end of the roller. Due to the limited length of the cutting wire, the rotation of the roller must be stopped when the cutting wire moves to its one end. Then the roller rotates reversely so that the cutting wire moves to the other end. Thus, cutting movement is not continuous, which causes the cutting wire to move not only from top to bottom but also from bottom to top during cutting of a workpiece. The lubrication of the cutting wire and chip removal will be difficult when the cutting wire moves from bottom to top. Meanwhile, the working table of wire sawing machine is of two degrees of freedom consisting of X-axis and Y-axis. The working table makes linear motion along X-axis and Y-axis directions to achieve machining of arbitrary contour shape of the workpiece by using linear interpolation mode during processing. However, when machining a component having a contour of arc or slash shape, contour lines formed by the linear interpolation mode, from the microscopic point of view, are actually a series of stepped straight segments along X-axis and Y-axis direction to obtain arc curves and slash, which makes these machined components have a rough surface and poor smoothness and unable to meet the requirement of modern high precision components processing. Thus, the wire cutting technology in the engineering is subject to a certain degree of restriction.

### SUMMARY OF THE INVENTION

The object of the present invention is to provide a wire sawing machine that allows continuous cutting movement of a cutting wire so as to realize one-way movement of the cutting wire, improve cutting efficiency, make lubrication of cutting wire and chip removal easier, and make the movement direction of the working table consistent with the cutting contour direction of workpiece and the cutting contour direction of workpiece consistent with the cutting loop direction of cutting wire, thereby greatly reducing the roughness of the machined surface and improving the surface finish and processing efficiency.

To achieve the above object, a wire sawing machine is disclosed which comprises a wire storage system, a working table, a cutting fluid lubrication system and a control system connected to the cutting fluid lubrication system. The working table comprises a machine base, a linear moving table for carrying out linear movement along X-axis and Y-axis directions respectively and being in sliding connection with the machine base, and a rotary table disposed above the linear movement table and being rotatable at 360-degree above the linear moving table. The wire storage system comprises an upper wire rack and a lower wire rack respectively arranged in the upper and lower outside of the rotary table, a group of guide wheels for wire storage, and an end to end connected cutting wire passing through the upper wire rack and the lower wire rack and wound around the outside of the group of guide wheels for wire storage. The control system is connected with the group of guide wheels, the rotary table and the linear moving table, respectively.

According to the above arrangement, a closed loop cutting wire is formed by an end to end connection so as to realize a one-way movement of the cutting wire, which reduces the stop of the cutting wire, thus improving cutting efficiency and achieving a more convenient lubrication of cutting wire and chip removal. The rotary table is rotatable at 360-degree on the horizontal plane so that the moving direction of the working table is consistent with the cutting contour direction of workpiece. Thus, arc curves and slash can be formed without using stepped straight line segments along X-axis and Y-axis direction, thus ensuring a smooth machined surface.

Further, guide wheels of the guide wheels group for wire storage are disposed in parallel to each other and are arranged in polygon so that the cutting wire contacts less than ½ circumference of each guide wheel. The cutting wire is wrapped around a plurality of guide wheels, so that the length of the closed cutting wire can be kept between 10 meters to 50,000 meters, which is enough to meet the cutting needs. As the contact surface of each guide wheel with the cutting wire is less than ½ circumference, the contact area between the cutting wire and the guide wheel is reduced, and hence wear can be reduced.

Further, the wire sawing machine may comprise a synchronization means through which the group of guide wheels connect with the control system. The synchronization means makes the guide wheels connect in pairs along the cutting wire movement direction. With the synchronization means, the guide wheels can achieve synchronous rotation, and the speed of the cutting wire can be kept the same everywhere, thus wire off or wire drawing phenomenon can be avoided. Meanwhile, only one drive unit is required for driving the operation of the group of guide wheels for wire storage.

Further, the surface of the guide wheel may be provided with a plurality of annular grooves which are parallel to each other along the axial direction of the guide wheel and are wound by the cutting wire. Accordingly, with the cutting wire wound in the annular grooves, mutual movement between the cutting wires can be avoided, and wear of the cutting wire can be reduced.

Further, the cutting fluid lubrication system may comprise an oil storage tank disposed at the bottom of the linear moving table, an oil pump electrically connected with the control system, and an oil passageway connected with the oil storage tank at one end, with the opposite end thereof being disposed above the upper wire rack, the oil pump being connected with the oil passageway. The lubricating fluid which is pumped by the oil pump from the oil storage tank flows out from the port on the upper wire rack through the oil passageway to lubricate the cutting wire between the upper wire rack and the lower wire rack, and then flow back to the oil storage tank after lubrication.

Further, the rotary table may comprise a support table on which a workpiece to be machined is placed, and a bracket which is arranged at the center of the bottom of the support table, fixed to the linear moving table and connected to the control system. The support table drives a workpiece to rotate along the bracket in the horizontal direction at 360-degree.

Further, the linear moving table comprises an X-axis moving table and a Y-axis moving table, both of which are in sliding connection with each other. The X-axis moving table makes processed components move along the X-axis direction, and the Y-axis moving table makes the processed components move along the Y-axis direction.

Further, the wire sawing machine may be provided with a first driving device, a second driving device and a third driving device, the bracket, the X-axis moving table and the Y-axis moving table are connected with the control system respectively through the first driving device, the second driving device and the third driving device correspondingly. The three driving devices are used to control the movements of the circular motion, linear motion along the X-axis and the Y-axis respectively, so as to provide a more accurate moving direction and speed of the working table, thus ensuring the machining precision.

Further, the wire sawing machine may be provided with a protective cover having a transparent observation window. The protecting cover may be arranged outside of the working table and surround the working table. The protective cover prevents the lubricating fluid of work from spraying to the outside to avoid environmental pollution. A process can be easy observed through the transparent observation window of the shield.

Further, the cutting wire may be a diamond wire saw which is suitable for cutting metal, stone, glass, ceramics, sapphire and other hard materials.

The following beneficial effects can be obtained from the above arrangements.
1) A cutting wire in closed loop is formed with an end to end connection so as to realize a one-way movement of the cutting wire, thus reducing the stop of the wire;
2) The cutting wire is wound around a plurality of guide wheels so as to provide a length of the closed cutting wire between 10 meters to 50,000 meters, which is enough long to meet various needs of different cuttings;
3) Since the rotary table can rotate at 360-degree on the horizontal plane, arc curves and slash can be obtained without using stepped straight line segments along the X-axis and Y-axis directions, thus a smooth machined surface is available;
4) As the cutting wire is wound in an annular groove, the mutual movement between the cutting wires can be avoided, and the wear of the cutting wire can be reduced; and
5) Three driving devices are used to control movements of circular motion and linear motion along X-axis and the Y-axis, respectively, so that the direction and speed of movement of the working table are more accurate to ensure machining precision.

### BRIEF DESCRIPTION OF THE DRAWINGS

Other features, objects and advantages of the present invention will emerge from a reading of the following detailed description and with regard to the accompanying drawings given by way of non-limitative example and in which:

FIG. 1 is a schematic view illustrating an internal construction of a wire saw machine according to an embodiment of the present invention;

FIG. 2 is a schematic view illustrating structures of a group of guide wheels for wire storage according to an embodiment of the present invention;

FIG. 3 is a schematic view illustrating a structure of a guide wheel according to an embodiment of the present invention; and

FIG. 4 is a schematic view showing connection between the controller and other components according to an embodiment of the present invention.

wherein,
1 wire storage system;
11 cutting wire, 12 guide wheels group for wire storage;
121 guide wheel; 122 annular grooves; 123 synchronous belt;
13 upper wire rack, 14 lower wire rack;
2 working table;
21 rotary table; 211 support table; 212 bracket;
22 linear moving table; 221 X-axis moving table; 222 Y-axis moving table;
23 machine base;
241 X-axis sliding rail; 242 Y-axis sliding rail;
3 control system;
31 first guide wheel for wire storage; 32 second guide wheel for wire storage;
33 third guide wheel for wire storage; 34 fourth guide wheel for wire storage;
301 outer barrel; 302 inner barrel; 303 annular grooves;
4 cutting fluid lubrication system;
41 oil storage tank; 42 oil pump; 43 oil passageway;
51 first motor; 52 second motor; 53 third motor;
6 protective cover; 61 observation window

### DETAILED DESCRIPTION

A clear and specific description about the technical solutions of the present invention will be given below with reference to the drawings. It would be appreciated by the skilled in the art that the embodiments presented are only a part of embodiments of the present invention for illustration purposes. Based on the embodiments disclosed in the application, various implementation and other embodiments can be obtained by those having ordinary skill in the art without inventive effort, and are deemed to be within the scope of the present invention.

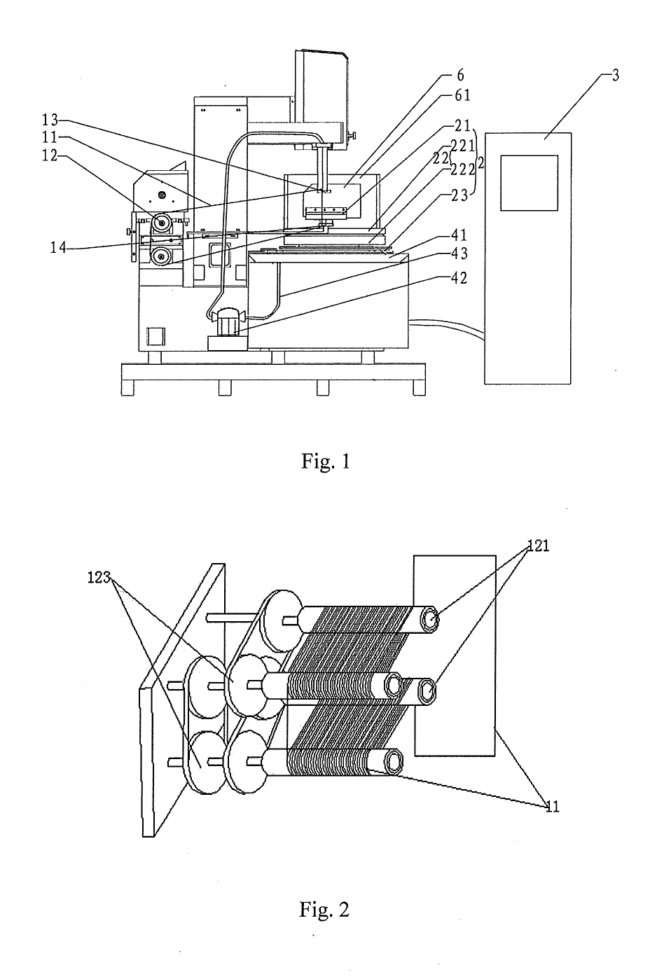

As shown in FIG. 1, a wire sawing machine according to an embodiment of the invention comprises a wire storage system 1, a working table 2, a control system 3 and a cutting fluid lubrication system 4. The working table 2 comprises a rotary table 21, a linear moving table 22 and a machine base 23. The linear moving table 22 comprises an X-axis moving table 221 and a Y-axis moving table 222. The rotary table 21 comprises a support table 211 and a bracket 212 which is provided at the center of the bottom of the support table 211 and fixed on the X-axis moving table 221. An X-axis sliding rail 241 is disposed between the X-axis moving table 221 and the Y-axis moving table 222. A Y-axis sliding rail 242 is disposed between the Y-axis moving table 222 and the machine base 23. A protective cover 6 having a transparent observation window 61 is arranged outside of the working table 2 to surround it.

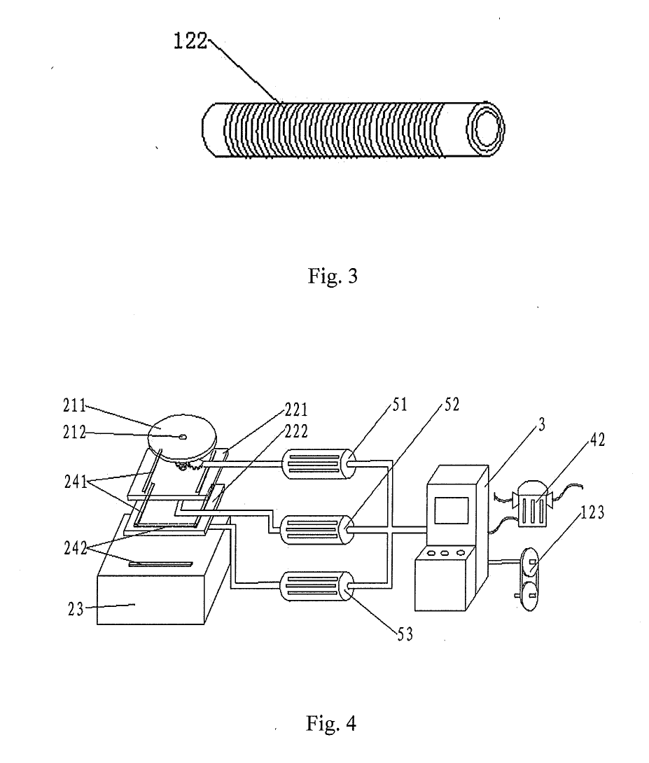

As shown in FIG. 2, the wire storage system comprises a cutting wire 11, guide wheels group for wire storage 12, an upper wire rack 13 and a lower wire rack 14. The upper wire rack 13 and lower wire rack 14 are arranged on the upper and lower side of the working table 2, respectively. The cutting wire 11 which is connected in an end to end way (i.e., head-to-tail ligation), passes through the upper wire rack 13 and the lower wire rack 14 and winds around the outside of the guide wheels group for wire storage 12. Guide wheels 121 of the guide wheels group for wire storage 12 is disposed in parallel to each other and are arranged in polygon so as to keep the cutting wire 11 to contact less than ½ circumference of each guide wheel 121. A plurality of annular grooves 122 are provided on the surface of the guide wheel 121. As shown in FIG. 3, annular grooves 122 are arranged in parallel to each other along the axial direction of the guide wheel 121. The cutting wire 11 is wound around the annular grooves 122 and hence on plurality of guide wheels 121 to ensure that the length of the closed cutting wire is between 10 m to 50,000 m. The guide wheels group for wire storage 12 connects with the control system 3 by synchronous belt 123 which makes each guide wheel 121 be connected in pairs along the travel route of the cutting wire.

As shown in FIG. 1, the cutting fluid lubrication system 4 comprises an oil storage tank 41 disposed at the bottom of the Y-axis moving table 222, an oil pump 42, and an oil passageway 43 connected between the oil storage tank 41 and the oil pump 42. The oil passageway 43 is connected with the oil tank 41 at one end and its opposite end is disposed above the upper wire rack 13.

With reference to FIG. 4, the bracket 212 connects with the control system 3 through the first motor 51, the X-axis moving table 221 connects with the control system 3 through the second motor 52, and the Y-axis moving table 222 connects with the control system 3 through the third motor 53. The oil pump 42 is in electrical connection with the controller system 3.

The operating of the present invention will be described as follows:

The controller of the control system 3 outputs signals generated according to a profile of the workpiece to be machined for controlling the motor to drive the rotary table in circular motion and to drive the X-axis moving table in linear motion along X-axis direction and the Y-axis moving table in linear motion along Y-axis direction respectively. Meanwhile, the controller also start the synchronization means to drive the guide wheel to rotate so that the cutting wire is driven to move during the rotation of the guide wheel. The workpiece placed on the support table is cut by the cutting wire positioned between the upper wire rack and the lower wire rack. In the meantime, the oil pump is started by the controller so that the lubricating oil which is drawn by the oil pump from the oil storage tank flows from the port of the upper wire rack along the cutting wire through the oil passageway for lubricating and cooling purpose during machining. The outflow of the lubrication fluid flows back to the oil storage tank disposed at the bottom of the working table for recycling.

It should be noted that the above description is only exemplified specific embodiments but not intended to limit the scope of this invention. Modifications, substitutions or variations may be conceived by those skilled in the art from the disclosure of the present application without departing from the concept, spirit and scope of this invention and shall be covered by the claims.

1. A wire sawing machine comprising a wire storage system, a working table, a cutting fluid lubrication system and a control system connected to the cutting fluid lubrication system,
wherein the working table comprises a machine base, a linear moving table conducting linear movement along X-axis and Y-axis directions respectively and being in sliding connection with the machine base, and a rotary table disposed above the linear movement table and being rotatable at 360-degree above the linear moving table,
wherein the wire storage system comprises an upper wire rack and a lower wire rack respectively arranged in the upper and lower outside of the rotary table, a guide wheels group for wire storage, and an end to end connected cutting wire passing through the upper wire rack and the lower wire rack and wound around the outside of the group of guide wheels for wire storage, and
wherein the control system is connected with the group of guide wheels, the rotary table and the linear moving table, respectively.

2. The wire sawing machine according to claim 1, wherein the guide wheels of the guide wheels group for wire storage are disposed in parallel to each other and are arranged in polygon so that the cutting wire contacts less than ½ circumference of each guide wheel.

3. The wire sawing machine according to claim 1, further comprising a synchronization means through which the guide wheels group for wire storage connects to the control system, said synchronization means allowing the guide wheels of guide wheels group for wire storage to connect in pairs along the cutting wire movement direction.

4. The wire sawing machine according to claim 3, wherein the surface of the guide wheel is provided with a plurality of annular grooves around which the cutting wire is wound, said plurality of annular grooves are parallel to each other along the axial direction of the guide wheel.

5. The wire sawing machine according to claim 4, wherein the cutting fluid lubrication system comprises
an oil storage tank provided at the bottom of the linear moving table,
an oil pump being electrically connected with the control system, and
an oil passageway connected with the oil storage tank at one end and being disposed above the upper wire rack at the opposite end, the oil pump being connected with the oil passageway.

6. The wire sawing machine according to claim 5, wherein the rotary table comprises:
a support table, and
a bracket disposed at the center of the bottom of the support table and fixed on the linear moving table, the bracket being connected to the control system.

7. The wire sawing machine according to claim 6, wherein the linear moving table comprises an X-axis moving table and a Y-axis moving table, the X-axis moving table being in sliding connection with Y-axis moving table.

8. The wire sawing machine according to claim 7, further comprising a first driving device, a second driving device and a third driving device through which the control system connects with the bracket, the X-axis moving table and the Y-axis moving table, respectively.

9. The wire sawing machine according to claim 8, further comprising a protective cover having a transparent observation window, wherein the protective cover is arranged outside of the working table and surrounded the working table.

10. The wire sawing machine according to claim 9, wherein the cutting wire is diamond wire saw.

11. The wire sawing machine according to claim 2, further comprising a synchronization means through which the guide wheels group for wire storage connects to the control system, said synchronization means allowing the guide wheels of guide wheels group for wire storage connect in pairs along the cutting wire movement direction.

12. The wire sawing machine according to claim 11, wherein the surface of the guide wheel is provided with a plurality of annular grooves around which the cutting wire is wound, said plurality of annular grooves are parallel to each other along the axial direction of the guide wheel.

13. The wire sawing machine according to claim 12, wherein the cutting fluid lubrication system comprises
an oil storage tank provided at the bottom of the linear moving table,
an oil pump being electrically connected with the control system, and
an oil passageway connected with the oil storage tank at one end and being disposed above the upper wire rack at the opposite end, the oil pump being connected with the oil passageway.

14. The wire sawing machine according to claim 13, wherein the rotary table comprises:
a support table, and
a bracket disposed at the center of the bottom of the support table and fixed on the linear moving table, the bracket being connected to the control system.

15. The wire sawing machine according to claim 14, wherein the linear moving table comprises an X-axis moving table and a Y-axis moving table, the X-axis moving table being in sliding connection with Y-axis moving table, and a first driving device, a second driving device and a third driving device through which the control system connects with the bracket, the X-axis moving table and the Y-axis moving table, respectively.

16. The wire sawing machine according to claim 15, further comprising a protective cover having a transparent observation window, wherein the protective cover is arranged outside of the working table and surrounded the working table.
